(19) United States
(12) Patent Application Publication
(10) Pub. No.: US 2012/0182329 A1
(43) Pub. Date: Jul. 19, 2012

(54) Low grey enhancement in the field emission display (FED) based on sub-Row driving (SRD) technology

(76) Inventors: Zhixian Lin, Fuzhou (CN); Tailiang Guo, Fuzhou (CN); Sheng Xu, Fuzhou (CN); Yongai Zhang, Fuzhou (CN)

(21) Appl. No.: 13/394,894

(22) PCT Filed: Mar. 16, 2011
(86) PCT No.: PCT/CN11/71845

§ 371 Date: Apr. 9, 2012

(30) Foreign Application Priority Data
Mar. 17, 2010 (CN) 201010126111.9

(51) Int. Cl. G09G 5/10

(52) U.S. Cl. 345/690

(57) ABSTRACT

This invention is involved with the discipline of the display manufacturing technique, especially a low grey enhancement method for the FED system based on a SRD grey modulation driving technique. The feature is which based on the sub-row grey modulation of the SRD technique, apply low grey enhancement to eliminate the low grey loss in the low grey image information. In addition, the low grey loss is modified by the time compensation, and the display quality of the image is improved.

### TECHNICAL FIELD

This invention is involved with the discipline of the display manufacturing technique, especially a low grey enhancement method for the FED system based on a SRD grey modulation driving technique.

### TECHNICAL BACKGROUND OF THE INVENTION

Field Emission Display (FED) is a new type of flat panel display. It has the advantage of high-quality image display as cathode ray tube (CRT), and also has the advantage of being light, thin, and low power consumption as liquid crystal display (LCD), and also has the advantage of large-area like popular POP advertisement nowadays. FED also has the advantages of high resolution, high contrast, wide visual angle, rapid response, high or low-temperature resistant, anti-vibration, low radiation and low cost in production, easy digital display, so it has wide market prospect. The driving circuit is the key part in the FED system, and it determines the function of the FED to the most. Grey modulation circuit is the key part of the FED driving circuit. It is a common difficulty due to the loss of materials and chips.

With the research and development of big-size and high-resolution FED, the current high-voltage chip cannot meet the requirement any more. Thus we could only utilize the current high-voltage integrated chips to the most extent to design circuits meeting the requirements of FED characteristics. The research of the new integrated grey modulation system for FED is essential to develop high-resolution and high grey-grade FED.

The grey ranking of the display device is the brightness level of the image from black to white colors. The more the grey ranking, the richer the color level of the image from black to white, the clearer the details, and the more delicate the image. As for the realization of monochrome and multi-color, the difference is: the realization of multi-color is to monochrome drive the three primary colors pixel independently, then synthesize them on the screen. The relationship between the grey level S and bits number n is: S=2ⁿ. In the case red, green, and blue three monochrome has S grey levels, it will generate S³ types of colors. For example, a 256 grey level RGB can generate 16.7 million colors. The grey level in color images is a major function specs in the aspect of display, an important index in flat panel display. Due to the difference in the structure, and operation principle for different types of display device, the realization of grey level is also varied. At the moment, there are main methods in grey modulation: amplitude modulation, spatial grey modulation and temporal grey modulation. Currently, the temporal grey modulation has the following types: frame grey modulation, subfield grey modulation, and pulse width modulation. The pulse width grey modulation can be easily realized through the digital circuit control and bring the grey information on the column signal pulse. It is the typical method to realize the grey level in flat panel display.

This invention is based on the sub-row grey modulation SRD technology in FED system, by adjusting the display order of those sub-rows, and the timing order, applying the low grey level enhancement method, to eliminate the low grey information loss, the image quality can be improved.

### SUMMARY OF THE INVENTION

In order to overcome the shortcoming of current technique, the main purpose of this invention is to provide with a low grey level enhancement modulation method based on the sub-row grey level modulation drive technique FED system, especially a method that can improve the quality of the color video image display in FED.

This invention takes the following technical scheme.

A method of low grey enhancement in the field emission display (FED) based on SRD technology, with the feature of: based on the sub-row grey modulation SRD technology, we enhance the low grey on the image information to eliminate the low grey loss, then modify the low grey loss by the time compensation, thus we improve the display quality of the image.

The sub-row grey modulation operates on one row, divided into many sub-rows according to the data bits, then each datum is displayed based on its weight; each sub-row is composed of the data transmission period and display period. During the data transmission period, the displayed data is sent to shift register, while during the data display period the data is locked and transported to high-voltage output. During the display period of a former sub-row, the data transmission of the latter sub-row can be processed. The key point of the sub-row grey modulation is that the data transmission and display are simultaneous.

The low grey enhancement modulation focuses on the problem that the rising edge and falling edge duration during the row scanning pulse will result in the invalid column driving pulse and no luminescence screen, it causes the data loss of the low grey image which affects the display effect. By adjusting the display order of those sub-rows, and the timing order, eliminate the low grey information loss, the image quality can be improved.

Next, we describe in details the low grey level modulation enhancement method in FED based on SRD technology, together with figures.

### BRIEF DESCRIPTION OF THE DRAWING

FIG. 1 is the overall circuit diagram for the FED display system based on the sub-row grey level modulation drive technology.

FIG. 2 is the principle diagram for the sub-row grey level modulation drive display.

FIG. 3 is the schematic diagram for the sub-row duration distribution.

FIG. 4 is the schematic diagram for the sub-row distribution after lowering bits.

FIG. 5 is the schematic diagram with the pulse rising and fall edges.

FIG. 6 is the schematic diagram for the column drive data loss caused by the rising and falling edges.

FIG. 7 is the schematic diagram for the two modulation method driving waveform with the same grey level.

FIG. 8 is the schematic diagram after the adjustment of the sub-row display order.

FIG. 9 is the schematic diagram for the influence of the rising and falling edge on the sub-row after the adjustment of the sub-row display order.

FIG. 10 is the schematic diagram for the data separation.

FIG. 11 is the schematic diagram for the data re-order.

FIG. 12 is the flow chart for the transmission and display program on the sub-rows after the adjustment of the sub-row order.

FIG. 13 is the schematic diagram for the system grey and luminescence level test after the adjustment of the sub-row order.

FIG. 14 is the schematic diagram for the system grey and luminescence level test without the adjustment of the sub-row order.

### DETAILED DESCRIPTION OF THE INVENTION

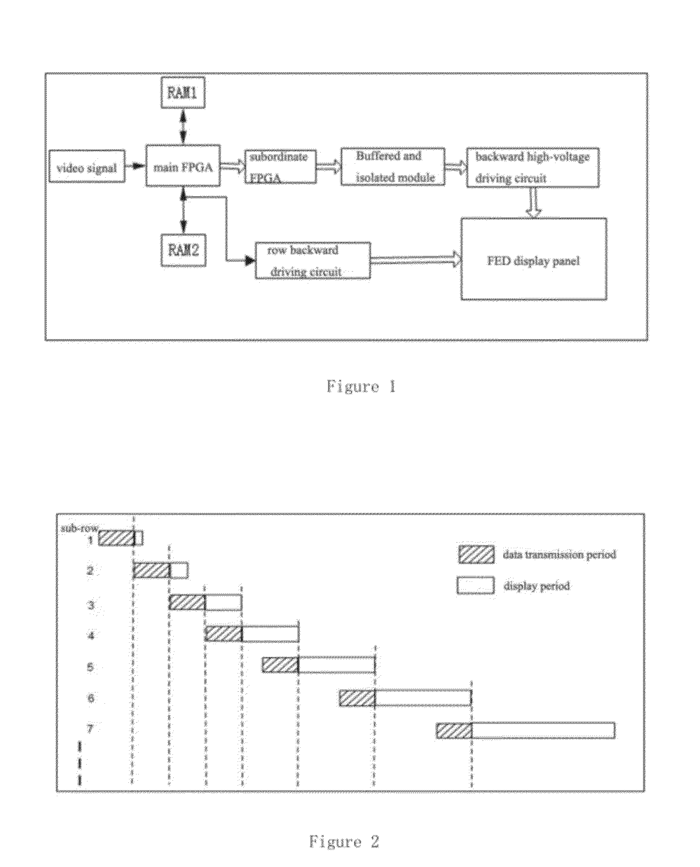

The FED system based on sub-row grey level modulation drive technology mainly is composed of two-level FPGA and backward high-voltage driving circuit. Shown in FIG. 1, in two-level FPGA, the main FPGA is mainly in charge of collecting forward video signal and execute corresponding image processing; the subordinate FPGA receive data and control signal after processing by main FPGA, then finish the complicated sub-row grey level modulation. Its main function is to divide and re-organize the data transmitted from the main FPGA, control the output pattern of the data, then generate the control signal needed by the backward driving chip STV7620, to realize the sub-row grey level modulation.

Sub-row grey level modulation is to output data by bits, and then display them based on their weight. Shown in FIG. 2, the sub-row grey level modulation operates on a row, i.e. divide the data in each row into many sub-rows, each sub-row is composed by the data transmission duration and display duration. During the data transmission duration (shadow part in figure) the displayed data are sent to the shift register, while during the display duration (white part in figure) the data are latched and transmitted to high-voltage output. Because the STV7620 has internal output latch, during the stable output state the shift register can execute the data transmission of the next period. During the display duration of the first sub-row, the data transmission of the second sub-row can be processed. The key point of the sub-row grey level modulation is that the data transmission and display are simultaneous, and it can reduce the non-luminescence time of the screen to the most.

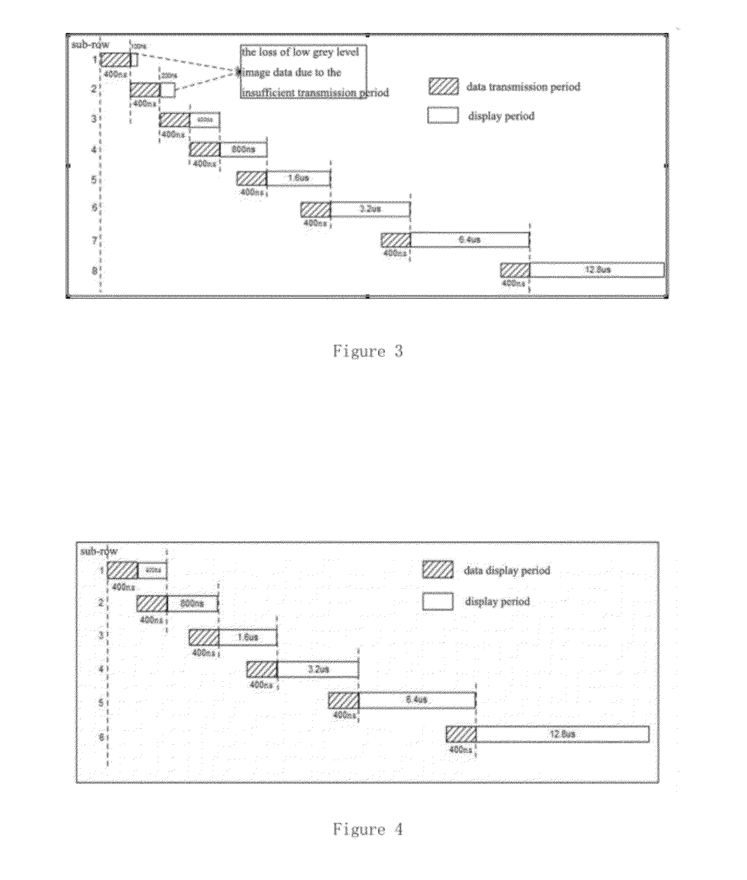

Shown in FIG. 3, the resolution of current FED panel is 800×3×600, with the field frequency of 60 Hz. Thus, the gating time of each row is about 27.7 us. In order to realize 256 grey level, with the duration of one row, if the data are sent out by 8 sub-rows, the duration ratio of each sub-row by weight is 12:4:8:16:32:64:128, thus the duration of the minimum sub-row (or sub-row 1) is about 100 ns. By this way, the durations of 8 sub-rows are 100 ns, 200 ns, 400 ns, 800ns, 1.6 us, 3.2 us, 6.4 us, and 12.8 us, respectively. Because the register length of the STV7620 high-voltage shift latch driver chip is 16 bits, while the fastest shift clock of the chip is 40M, transmission is by bit, so it takes 400 ns to finish the data transmission of one sub-row. If the image pixel data applies 8 bit, ie. divide the duration of one row into 8 sub-rows, then the display durations of the minimum two sub-rows are 100 ns and 200 ns, respectively. Both are smaller than the data transmission duration (400 ns). If we continue to apply 8 bit data for grey level display, it will cause the loss of low grey level image data due to the insufficient transmission duration for the minimum two sub-rows. Furthermore, if the assigned duration for the low grey level is too short (minimum grey level 100 ns), for the reason that the response time of both the device and display panel will affect the image display of the low grey level part, it will greatly undermine the quality of image display.

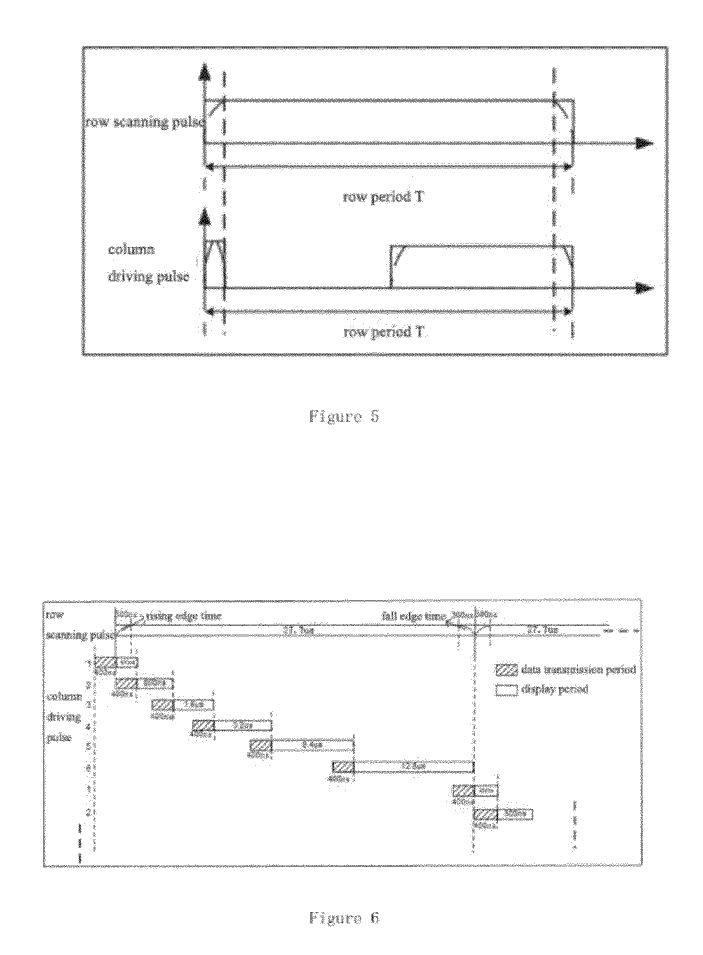

Shown in FIG. 4, we apply error diffusion method to diffuse Sub-row 1 and 2 into other sub-rows as error factor, and use 6-bit to display, to some extent it improves the image quality caused by the data loss of the low grey level. However, shown in FIGS. 5 and 6, because it exists both rising and falling edge times in the backward row scanning drive pulse, from the test, both rising and falling edge time is 300 ns for the backward row scanning drive pulse. Because FED display screen is luminescent, the corresponding column and row signals must be valid, while during the period of the scanning pulse edges it will make the column drive pulse invalid, i.e. the column drive pulse cannot make the screen luminescent. It will lead to the data loss for the image information, especially the image for the low grey level. So it will greatly affect the display effect of the images. Therefore, by only applying error diffusion method to reduce the data bits to improve the image quality cannot achieve the high-fidelity clear video images.

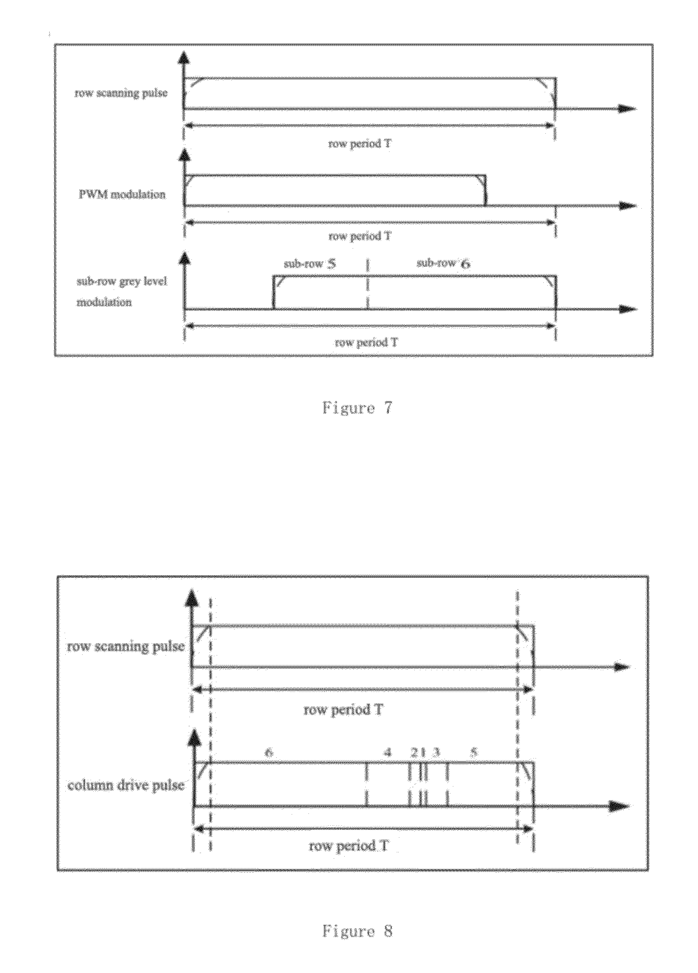

From the ideal case, i.e. we do not consider both the rising and falling edge times of the output pulse, the effect of the PWM modulation and the sub-row grey level modulation drive method is the same. Because in both cases, the key point is to within the time period of a single row, the image grey level is realized through the continuous time length of the pulse. The only difference is that the position on the time axis is not the same. Shown in FIG. 7, when the grey level is 110000, the pulse width of the above two drive methods both takes the three fourths of one period.

However, the real case is that either row or column drive chips has certain response time. Therefore, in the analysis of the function of the sub-row grey level modulation and the existent problems, we must consider the effect of both rising and falling edge times of the output pulses.

Regarding the low grey level loss caused by both rising and falling edge time of the row scanning pulse, our design adjusts the display order of sub-rows, i.e. the display order of six sub-rows does not follow the data bit from low to high, shown in FIG. 8, we display Sub-rows 5 and 6 with the highest weight at the beginning and end of the row effective period, while Sub-rows 1 and 2 with the lowest weight in the middle of the row effective period.

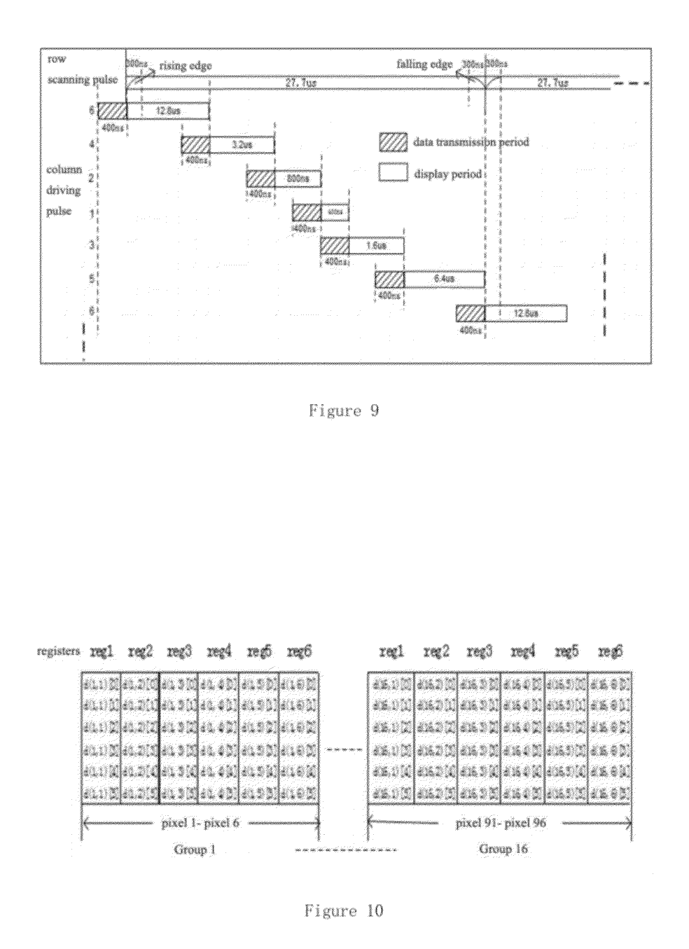

Shown in FIG. 9, although this adjustment cannot avoid the loss of the overall luminescent time, the corresponding luminescent times of Sub-rows 5 and 6 with higher weight are 6.4 and 12.8 us, respectively. They are longer than both the rising and falling edge time of the row scanning pulse. Therefore, the effect of the overall display image quality is not serious, and will not cause the data loss of the low grey level image information.

Realization of Circuit

First, we divide the original input data, after the error diffusion process, the grey level information of each pixel is 6 bit, with 800 columns data for each row. Because there are 96 outputs on each STV7620 high-voltage shift latch driver, we need 9 pieces of high-voltage shift latch driver. We apply parallel transmission method, need to divide 800 column data into 9 parts, corresponding to each high-voltage shift latch driver. Thus, the first step for data processing is to divide. Next, we have detailed explanation on one part among the nine. Shown in FIG. 10, where reg1-reg6 represents six registers, d(i,j)[k] is the kth data in the ith group jth resister, based on the adjacent position every 6 bits i.e, 6 pixels for one group, corresponding to reg1-reg6 6 registers in group, respectively. In each register a pixel with 6 bits is stored. The rest 8 parts follow the same method to divide. When the data is stable, 6 bits in each data was written in its corresponding shift register.

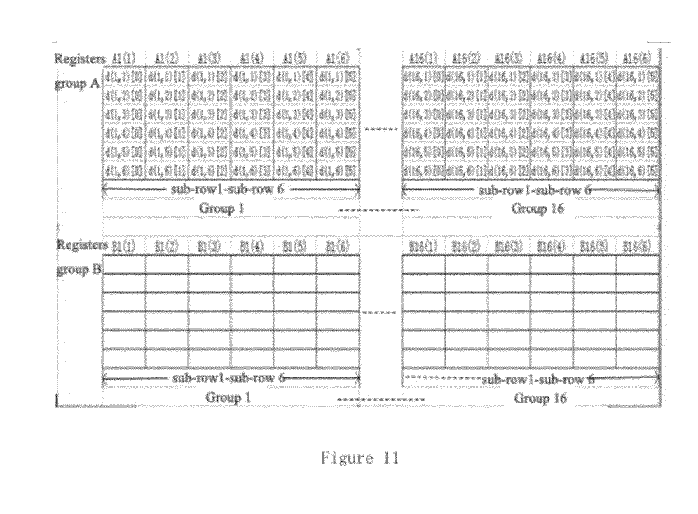

Next step is data re-organization. We create two shift register groups A and B, each group contains six 6-bit length shift register. Because there are 96 outputs on each STV7620 high-voltage shift latch driver, Buffer 1 stores 96 pixel data, divided into 16 groups. The divided data shown in FIG. 11, where Ai(j) represents the jth register in ith group in register A, Bi(j) represents the jth register in ith group in register B, d(i,j)[k] is the kth data in the ith group jth resister, for re-organization. Each 6 adjacent input data for one group, and the same position in the 6 bits was pick up accordingly, forming new 6 bits, i.e. the lowest 0 bit in each group 6 registers re-organizes the first register reg1 in each group, the second lowest 1 bit in each group 6 registers re-organizes the second register reg2 in each group, and so on, till the highest 6 bit in each group 6 registers re-organizes the 6^{th} register reg1 in each group. Thus, the data of each new bit corresponds to certain sub-row. When 6 bits in one group is all written into Group A register, the 6 bits data in next group will be written in another Group B shift register. Finally, we put those re-organized data into the buffer. Then, each time a sub-row is displayed, we only need to read out the corresponding data from the buffer while do not have to scan all the data.

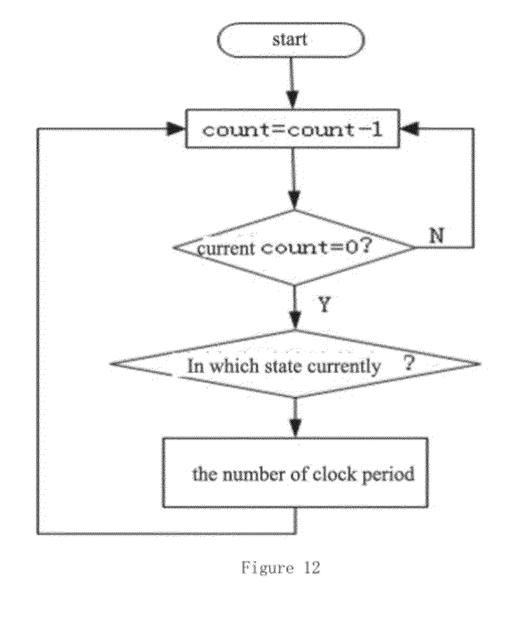

After data division and re-organization, we are able to adjust the sub-row grey level display data by controlling the data output. We apply the design method of the finite state machine, to read out the needed sub-row data for the output display. Detailed operation is: we set a state register to store 6 state 001, 010, 011, 100, 101, and 110 corresponding to 6 sub-rows, and then set a count register COUNT, to store the number of clocks corresponding to each sub-row, for example each sub-row follows the order of 6-4-2-1-3-5 to transmission display, and the display period for each sub-row is 12.8 us, 1.6 us, 800 ns, 400 ns, 1.2 us and 2 us, and the numbers of periods are 512, 128, 32, 16, 64, and 256, respectively. The program flow diagram is shown in FIG. 12.

As for the low grey level loss caused by the screen response time, we apply time compensation method to modify the low grey level loss. The designed field frequency is 60 Hz, and the resolution is 800×600, so the gating time of each row is 27.7 us. This system applies 40M clock, and so each row gating time contains 1108 clock period. Through the error dissipation processing, the pixel data width is 6 bits, and the time weight for each sub-row is 1:2:4:8:16:32. The lowest sub-row is 400 ns, so the length of each sub-row is 16, 32, 64, 128, 256, and 512 clock periods. The total period of each sub-row is 1024 time period, so each row there are 84 extra clock periods. The response time of FED screen is about 2 us, equal to 80 clock periods. So, the key issue of time compensation method is to divide the gating time into two parts, one part is for normal grey level display, and the other is for the compensation display.

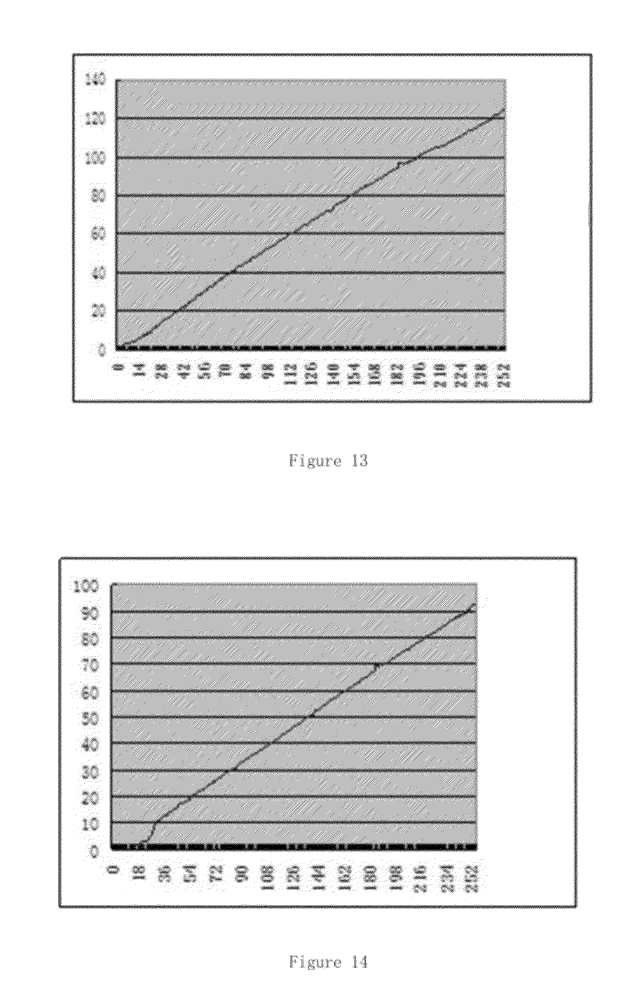

After the normal function of drive circuit, we test the grey level of the image after the FED display. The test method is to fix the drive voltage of STV7620, then change the display image and gradually increase the grey level value. From luminescence calculation screen, we obtain the grey level luminescence plot shown in FIG. 13.

FIG. 14 is the test diagram of the original system grey scale. By comparing the above two figures, we found that at the low grey scale, the sub-row grey level modulation system, because we applied low grey level enhancement calculation, the low grey level loss is eliminated, and the luminescence is increased compared to original system, thus it improves the display quality of the image.

The above case is optimized based on our invention. Any change based on the technique on this invention, the function does not surpass the range of this invention, all belongs to the protection of this invention.

1. A method of low grey enhancement in the field emission display (FED) based on sub-Row driving (SRD) technology, wherein based on the sub-row grey modulation SRD technology, we enhance the low grey on the image information to eliminate the low grey loss, then modify the low grey loss by the time compensation, thus we improve the display quality of the image.

2. A method according to claim 1, wherein the sub-row grey modulation operates on one row, divided into many sub-rows according to the data bits, then each datum is displayed based on its weight; each sub-row is composed of the data transmission period and display period. During the data transmission period, the displayed data is sent to shift register, while during the data display period the data is locked and transported to high-voltage output. During the display period of a former sub-row, the data transmission of the latter sub-row can be processed. The key point of the sub-row grey modulation is that the data transmission and display are simultaneous.

3. A method according to claim 1, wherein the low grey enhancement modulation focuses on the problem that the rising edge and falling edge duration during the row scanning pulse will result in the invalid column driving pulse and no luminescence screen, it causes the data loss of the low grey image which affects the display effect. By adjusting the display order of those sub-rows, and the timing order, eliminate the low grey information loss, the image quality can be improved.

4. A method according to claim 3, wherein when the number of sub-rows is 6, according to the display order of 1-2-3-4-5-6, because the display period of the low sub-row, which leads to data loss, we adjust the order following 6-4-2-1-3-5 or 6-4-1-2-3-5, this can avoid the loss of the low grey information, then the display quality of the image is improved.

5. A method according to claim 1, wherein because the low grey loss caused by the reaction time is existed in the display panel, the low grey loss is modified by the time compensation, so that the display quality of the image is improved.

6. A method according to claim 5, wherein the described time compensation method is to divide the one row time to two parts, one is used for normal grey display, and the other for the compensation display.
